(19) United States
(12) Patent Application Publication
(10) Pub. No.: US 2007/0063874 A1
(43) Pub. Date: Mar. 22, 2007

(54) Method and device for determining the position and/or the anticipated position of a vehicle during a parking operation in relation to the oncoming lane of a multi-lane roadway

(76) Inventors: Christian Danz, Stuttgart (DE); Cyrille Bollengier, Gerlingen (DE)

Correspondence Address: KENYON & KENYON LLP, ONE BROADWAY, NEW YORK, NY, 10004, US

(21) Appl. No.: 10/564,371

(22) PCT Filed: May 26, 2004
(86) PCT No.: PCT/EP04/50928

§ 371 Date: Jul. 19, 2006

(30) Foreign Application Priority Data
Jul. 21, 2003 (DE) 10332961.7

(51) Int. Cl. G08G 1/14

(52) U.S. Cl. 340/932.2

(57) ABSTRACT

A method and a device for determining the position and/or the anticipated position of a vehicle during a parking operation in relation to the oncoming lane of a multi-lane roadway. The object is to provide a method and a device which recognize the protrusion of a vehicle into the oncoming lane of a multi-lane roadway during a parking operation in a timely manner and, if necessary, activate suitable means for preventing the protrusion into the oncoming lane. Due to the fact that the position of the oncoming lane in relation to the vehicle at the beginning of the parking operation, the anticipated parking trajectory of the vehicle, and potential intersections of the anticipated parking trajectory with the oncoming lane are determined, a signal may be provided in the presence of at least one intersection of the parking trajectory with the oncoming lane; the signal may be processed into an alert of the driver of the vehicle or into a timely deceleration of the vehicle.

### FIELD OF THE INVENTION

The present invention relates to a device and a method.

### BACKGROUND INFORMATION

Increasing traffic density and increased development of open spaces continuously restrict the room for traffic, in particular in metropolitan areas. The available parking areas are becoming more cramped and the search for a suitable parking space and the steadily increasing traffic volume put additional stress on the driver. In particular when backing into a parking space, the operator of a vehicle must be particularly focused. The driver must watch the space to the rear of the vehicle, in particular, in order to correctly maneuver the vehicle into the parking space. For this reason, the attention of the driver of a vehicle is primarily reduced in the vehicle's forward direction. There is the possibility during a backward parking operation that, when steering to the right (steering direction of the steering wheel) while backing up, the driver-side front end of the vehicle protrudes into the opposite lane of traffic. This results in a potentially dangerous situation which, in particular in the case of small parking spaces, may not always be avoidable.

Various devices are known for assisting the driver of a vehicle during parking, such as a parking distance control device or a semi-autonomous or fully autonomous parking assistance. These devices simplify in particular the selection of a parking space and the targeted successful steering of the vehicle. The above-mentioned devices according to the related art have the disadvantage that none of the above-mentioned devices signals or prevents a potentially imminent protrusion of the vehicle into the opposite traffic lane or alerts the driver to such a dangerous situation.

### SUMMARY OF THE INVENTION

Therefore, it is the object of the present invention to provide a method and a device which detect a protrusion of a vehicle into the oncoming lane of a multi-lane roadway during a backward parking operation in a timely manner and, if necessary, activate suitable means for preventing the protrusion into the oncoming lane.

The method according to the present invention is characterized by the following method steps:
determining the position of the opposite lane of traffic in relation to the vehicle at the beginning of the parking operation,
determining the vehicle's anticipated parking trajectory,
determining potential intersections of the anticipated parking trajectory with the opposite lane, and
providing a signal in the presence of at least one intersection of the parking trajectory with the opposite lane, the signal being processed by means.

The above-mentioned method makes it possible to determine the position of the vehicle to be parked with regard to the lanes prior to the parking operation, as well as the probable parking trajectory, i.e., the path to be traveled by the vehicle. It is thereby possible to conclude in advance whether the vehicle will protrude into the opposite lane during the entire parking operation. In the event of the vehicle's protrusion into the oncoming lane, a signal, which is processed by suitable means, preferably means for alerting the driver of the motor vehicle, or means for braking the vehicle is provided according to the present invention. According to the present invention, it may thereby be achieved that the driver of a motor vehicle, who, during a backward parking operation, pays little attention to the area ahead of the vehicle, in particular the opposite lane including objects of the opposite traffic (vehicles), is alerted in the event of an imminent protrusion of the vehicle into the oncoming lane and thus a possible collision with vehicles in the opposite lane. It is alternatively provided that the vehicle is decelerated via corresponding means before it is able to protrude into the oncoming lane. This increases the active traffic safety of the vehicle in particular, since a collision with oncoming traffic in the oncoming lane, primarily during backward parking operations, may be prevented.

The present invention provides that, during execution of the method, the size of a parking space is determined using ultrasonic sensors. This and all determined data are then advantageously processed via a data processing unit, the data processing unit being an onboard computer of a vehicle according to the present invention.

As advantageous embodiments it is provided that the means is a device for alerting the driver of the vehicle, the means for alerting the driver of the vehicle being in particular an acoustic, a visual, and/or a haptic means, or the means being a device for braking the vehicle.

The vehicle's position at the beginning of the parking operation and the position of the oncoming lane in relation to the vehicle at the beginning of the parking operation are preferably determined using ultrasonic sensors, radar sensors, lidar sensors, video sensors, or other distance sensors. Moreover, the anticipated final parking position, which results mainly from the size of the parking space, is determined using ultrasonic sensors. Using mathematical computations, the parking trajectory may be calculated from the determined data via a data processing unit for example, preferably the onboard computer of a motor vehicle.

A device according to the present invention for determining the position and/or the anticipated position of a vehicle during a parking operation in relation to the oncoming lane of a multi-lane roadway includes:
means for determining the position of the oncoming lane in relation to the vehicle at the beginning of the parking operation,
means for determining the anticipated parking trajectory of the vehicle,
means for determining potential intersections of the anticipated parking trajectory with the oncoming lane,
means for providing a signal in the presence of at least one intersection of the parking trajectory with the oncoming lane, the signal being processed using means.

The means for determining the position of the oncoming lane in relation to the vehicle preferably has at least one ultrasonic sensor.

Another embodiment of the present invention provides for the use of potentially existing cameras of a video system in the vehicle to classify oncoming vehicles in the oncoming lane in order to generate an alert and output it to the driver only in the event of a real danger during the parking operation, i.e., in the event of a high probability of a collision.

In another preferred design variant of the present invention, the dangerousness of the situation may be classified by a semi-autonomous parking system and, in the presence of a dangerous situation, automatic and timely braking may be triggered to avoid a collision.

### BRIEF DESCRIPTION OF THE DRAWINGS

The present invention is subsequently explained in greater detail in an exemplary embodiment based on the appended drawing.

FIG. 1 shows the protrusion into the oncoming lane of a vehicle performing a backward parking operation, and

FIG. 2 shows a vehicle having a device according to the present invention for determining the position and/or the anticipated position of the vehicle during the parking operation.

### DETAILED DESCRIPTION

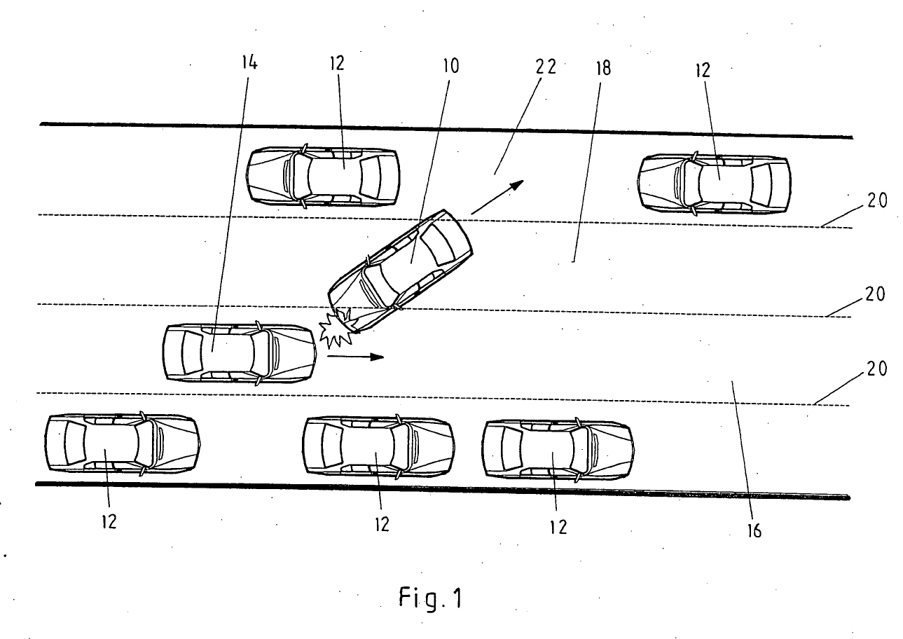

FIG. 1 schematically shows the protrusion of a vehicle 10 into oncoming lane 16. Parking space 22 is very tight in particular in the case of dense traffic volume, as in metropolitan areas, for example. This may result in the driver of motor vehicle 10 having to rely on backing into a tight parking space 22 between parked vehicles 12. It is often unavoidable that vehicle 10 crosses lane boundary 20 of its own lane 18 during the backward parking operation, thereby protruding into oncoming lane 16. This represents a potentially dangerous traffic situation due to the possible collision with vehicles 14 in the oncoming traffic.

To avoid such collisions during a backward parking operation, in which the driver of vehicle 10 normally pays little attention to the area in front of the vehicle and oncoming lane 16, the present invention provides for a protrusion into oncoming lane 16 to be detected so early that an alert may be output to the driver of vehicle 10, for example, which results in the parking operation involving a protrusion into oncoming lane 16 being aborted in a timely manner. It is alternatively possible to effect automatic braking of vehicle 10. The device according to the present invention is able to be particularly advantageously integrated into vehicles already having a parking distance control device (PLV) or a semi-autonomous Park Pilot (SPA) since the necessary ultrasonic sensors are already pre-installed in vehicle 10 and may be used. If vehicle 10 threatens to protrude into oncoming lane 16, the driver is alerted to a potentially dangerous situation via an appropriate signal (visual, acoustic, haptic).

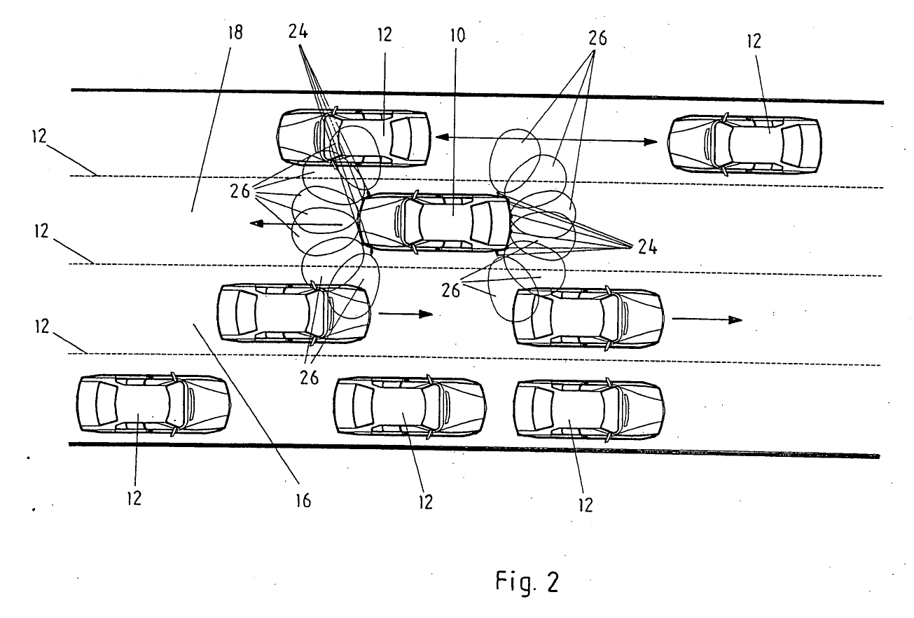

Ultrasonic sensors 24 may be used to determine whether a protrusion into oncoming lane 16 is imminent, as schematically shown in FIG. 2. Ultrasonic sensors 24 have a sample area 26. Radar sensors, lidar sensors, video sensors, or other distance sensors may also be used instead of ultrasonic sensors. Parked vehicles 12 as well as vehicles 14 in oncoming lane 16 are recorded within this sample area 26. Image data of a video-based lane departure warning (LDW) system may be additionally used. The LDW system displays the curb on the right side and, if applicable, center line 20 of the lane (represented by 16, 18). Based on the ultrasonic data and the possibly existing LDW data, at least one accurate determination of the position of vehicle 10 within lane 18 is possible. Based on the computed parking trajectory, it may thus also be determined whether vehicle 10 protrudes into oncoming lane 16 during the parking operation. If no video-based LDW system is integrated into the vehicle, the alert may be generated based only on the ultrasonic data of ultrasonic sensors 24. Based on ultrasonic sensors 24 installed all around the vehicle, a surroundings map is generated in which the positions of parked vehicles 12 are available. In addition, using ultrasonic sensors 24, situated on both vehicle sides and pointing to the sides, the distance to parked vehicles 12 and, if present, vehicles 14 of the oncoming traffic is measured during a parking space measurement. Based on the information about the distance of vehicle 10 to be parked from parked vehicles 12, the distance to vehicles 14 passing in oncoming traffic, and the length of the present parking space, a conclusion may be drawn about the probability of a protrusion into oncoming lane 16.

The present invention is not restricted to the exemplary embodiments represented here. It is possible to implement further design variants by combining and modifying the mentioned means and features without departing from the scope of the present invention.

1-10. (canceled)

11. A method for determining at least one of a position and an anticipated position of a vehicle during a parking operation in relation to an oncoming lane of a multi-lane roadway, comprising:
determining a position of the oncoming lane in relation to the vehicle at a beginning of the parking operation;
determining an anticipated parking trajectory of the vehicle;
determining at least one potential intersection of the anticipated parking trajectory with the oncoming lane; and
providing a signal in the presence of at least one actual intersection of the parking trajectory with the oncoming lane, the signal being processed.

12. The method as recited in claim 11, wherein:
the anticipated parking trajectory is determined based on a position of the vehicle at the beginning of the parking operation and an anticipated final parking position of the vehicle.

13. The method as recited in claim 11, further comprising:
comparing the anticipated parking trajectory of the vehicle during the parking operation to an actually driven parking trajectory; and
determining a remaining parking trajectory to be anticipated based on the comparing.

14. The method as recited in claim 12, wherein:
the position of the vehicle at the beginning of the parking operation, the position of the oncoming lane in relation to the vehicle at the beginning of the parking operation, and the anticipated final parking position of the vehicle are determined using at least one of an ultrasonic sensor, a radar sensor, a lidar sensor, a video sensor, a steering angle sensor, and a lane departure warning system.

15. The method as recited in claim 11, further comprising:
classifying an object approaching the vehicle in the oncoming lane with regard to an actual level of danger of the object in a potential collision with the vehicle via a video-based camera system.

16. The method as recited in claim 15, further comprising:
in the presence of the at least one actual intersection, providing a signal only if the object approaching in the oncoming lane presents a high level of danger in the potential collision.

17. A device for determining at least one of a position and an anticipated position of a vehicle during a parking operation in relation to an oncoming lane of a multi-lane roadway, comprising:
an arrangement for determining a position of the oncoming lane in relation to the vehicle at a beginning of the parking operation;
an arrangement for determining an anticipated parking trajectory of the vehicle;
an arrangement for determining at least one potential intersection of the anticipated parking trajectory with the oncoming lane; and
an arrangement for providing a signal in the presence of at least one actual intersection of the parking trajectory with the oncoming lane, the signal being processed.

18. The device as recited in claim 17, wherein:
the arrangement for determining the position of the oncoming lane in relation to the vehicle includes one of at least one ultrasonic sensor, at least one radar sensor, at least one lidar sensor, and at least one video sensor.

19. The device as recited in claim 17, wherein:
the arrangement for determining the position of the oncoming lane in relation to the vehicle is connected to an onboard computer of the vehicle.

20. The device as recited in claim 17, further comprising at least one of:
an arrangement for processing the provided signal and for alerting a driver of the vehicle; and
an arrangement for interrupting the parking operation.
